(19) United States
(12) Patent Application Publication
(10) Pub. No.: US 2011/0317197 A1
(43) Pub. Date: Dec. 29, 2011

(54) PRINTER SERVER TYPE PRINT SYSTEM

(75) Inventors: Shinji Makishima, Shizuoka-ken (JP); Kazuhiro Ogura, Kanagawa-ken (JP); Akihiro Mizutani, Shizuoka-ken (JP); Toshihiro Ida, Shizuoka-ken (JP); Yusuke Hamada, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/169,114

(22) Filed: Jun. 27, 2011

Related U.S. Application Data
(60) Provisional application No. 61/359,183, filed on Jun. 28, 2010.

(51) Int. Cl. G06K 15/02

(52) U.S. Cl. 358/1.13

(57) ABSTRACT

According to one embodiment, a printer server type print system includes plural digital multi-function peripherals, an information processing apparatus and a printer server. The information processing apparatus includes a display unit, an input unit and a first control unit. The display unit is configured to display information of the plural digital multi-function peripherals. The input unit is configured to accept setting of at least one digital multi-function peripheral allowed for outputting among the plural digital multi-function peripherals. The first control unit is configured to transmit a print job including information of the digital multi-function peripheral allowed for outputting. The printer server includes a memory and a second control unit. The second control unit is configured to manage the print job stored in the memory.

### CROSS-REFERENCE TO RELATED APPLICATIONS

This application is based upon and claims the benefit of priority from Provisional Application No. 61/359,183, filed on Jun. 28, 2010, the entire contents of which are incorporated herein by reference.

### FIELD

Embodiments described herein relate generally to a printer server type print system.

### BACKGROUND

In order to prevent information from leaking due to forgetting about taking a printed matter, security printing is proposed in which an MFP can not output a document based on a print job unless a user authenticates his/her printing in the MFP by using an IC card or the like. A printer server type print system is proposed, which improves the convenience of the security printing. In the printer server type print system, a printer server once stores a print job of a document created in a client PC for each user, and when the user personally authenticates his/her printing in an arbitrary MFP (Multi Function Peripheral), the arbitrary MFP can output the document based on the print job stored in the printer server.

The printer server type print system as stated above is often used in an office. In the printer server type print system, a simple method using an IC card storing a number for identifying a user is used instead of strict authentication requiring a password. Thus, there is a high risk of unauthorized printing due to the loss or forgery of the IC card, and this method is not sufficient as a countermeasure against information leakage. On the other hand, the strict authentication requiring the password impairs the practicality of the system.

In order to prevent information leakage by unauthorized printing to the utmost, it is conceivable that an MFP that can output a document based on a print job is limited for each user. However, since this requires that the administrator grasps the seat position of the user in advance and sets the access right to the MFP, the flexibility of the system is lost.

### BRIEF DESCRIPTION OF THE DRAWINGS

FIG. 1 is a view showing a printer server type print system of a first embodiment.

FIG. 2 is a block diagram showing a structure of the printer server type print system of the first embodiment.

FIG. 3 is a view showing a job management table of the first embodiment.

FIG. 4 is a view showing an MFP management table of the first embodiment.

FIG. 5 is a view showing a network address-position information table of the first embodiment.

FIG. 6 is a view showing a print log table of the first embodiment.

FIG. 7 is a view showing a certificate management table of the first embodiment.

FIG. 8 is a screen view of print setting of the first embodiment.

FIG. 9 is a screen view of print setting of the first embodiment.

FIG. 10 is a screen view of print setting of the first embodiment.

FIG. 11 is a screen view of print setting of a second embodiment.

FIG. 12 is a view showing encryption of PJL of the second embodiment.

FIG. 13 is a flowchart showing the encryption of the PJL of the second embodiment.

### DETAILED DESCRIPTION

In general, according to one embodiment, a printer server type print system includes plural digital multi-function peripherals, an information processing apparatus and a printer server. The information processing apparatus includes a display unit, an input unit and a first control unit. The display unit is configured to display information of the plural digital multi-function peripherals. The input unit is configured to accept setting of at least one digital multi-function peripheral allowed for outputting among the plural digital multi-function peripherals. The first control unit is configured to transmit a print job including information of the digital multi-function peripheral allowed for outputting. The printer server includes a memory and a second control unit. The second control unit is configured to manage the print job stored in the memory.

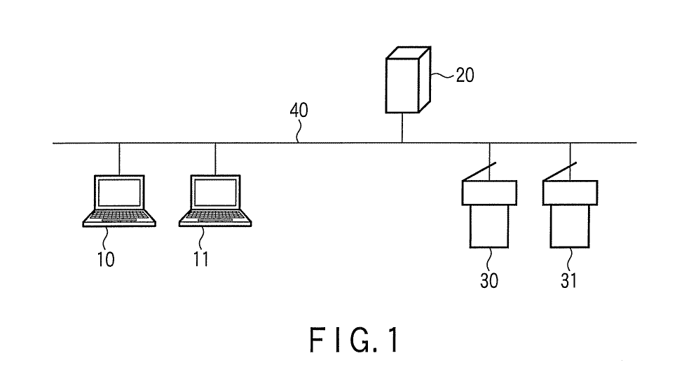

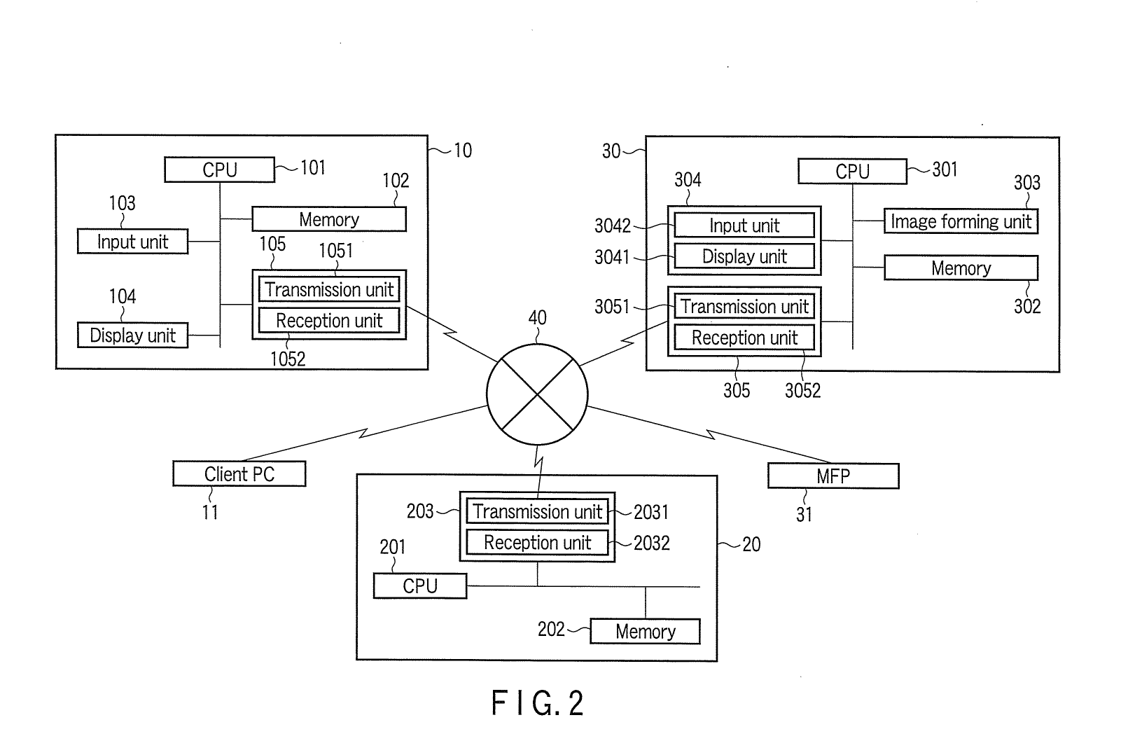

Hereinafter, a first embodiment will be described with reference to the drawings. FIG. 2 is a view showing a printer server type print system of the first embodiment. The printer server type print system includes a client PC 10, a client PC 11, a printer server 20, an MFP (digital multi-function peripheral) 30 and an MFP 31. The respective apparatuses included in the printer server type print system are connected so as to enable bidirectional communication through a network 40. Incidentally, although FIG. 1 shows the two client PCs and the two MFPs, the numbers of them may be respectively three or more.

FIG. 2 is a block diagram showing the structure of each of the apparatuses of the printer server type print system of the first embodiment. The client PC 10 is registered in the printer server 20, and has a function to transmit a print job to the printer server 20. The client PC 11 is the same. The printer server 20 has a function to temporarily store (register) a print job for each user. The MFP 30 has a function to selectively print a document based on a print job stored in the printer server 20. The MFP 31 is the same.

First, the structure of the client PC 10 will be described. Since the structure of the client PC 11 is the same as the structure of the client PC 10, its description will be omitted. The client PC 10 includes a CPU 101, a memory 102, an input unit 103, a display unit 104 and a communication unit 105. The CPU 101 controls the operations of the respective units of the client PC 10. The memory 102 stores programs and various information. The input unit 103 accepts various inputs from the user. The display unit 104 displays various information. The communication unit 105 connects the client PC 10 to the network 40. The communication unit 105 includes a transmission unit 1051 and a reception unit 1052. The transmission unit 1051 transmits information to another apparatus in the system through the network 40. For example, the transmission unit 1051 transmits a print job of a created document to the printer server 20. The reception unit 1052 receives information from another apparatus in the system through the network 40.

Next, the structure of the printer server 20 will be described. The printer server 20 includes a CPU (control unit) 201, a memory 202 and a communication unit 203. The CPU 201 controls the operations of the respective units of the printer server 20. The memory 202 stores programs and various information. The various information stored in the memory 202 will be described later. The communication unit 203 connects the printer server 20 to the network 40. The communication unit 203 includes a transmission unit 2031 and a reception unit 2032. The transmission unit 2031 transmits information to another apparatus in the system through the network 40. For example, the transmission unit 2031 transmits a print job stored in the memory to the MFP 30. The reception unit 2032 receives information from another apparatus in the system through the network 40. For example, the reception unit 2032 receives a print job from the client PC 10.

Next, the structure of the MFP 30 will be described. Incidentally, since the structure of the MFP 31 is the same as the structure of the MFP 30, its description will be omitted. The MFP 30 includes a CPU (control unit) 301, a memory 302, an image forming unit 303, a control panel 304 and a communication unit 305. The CPU 301 controls the operations of the respective units of the MFP 30. The memory 302 stores programs and various information. The image forming unit 303 prints image information of a document based on a print job to a sheet and outputs. The control panel 304 integrally includes a display unit 3041 and an input unit 3042. The display unit 3041 is a liquid crystal monitor to display various information. The input unit 3042 is a touch panel to which necessary items can be inputted. The communication unit 305 connects the MFP 30 to the network 40. The communication unit 305 includes a transmission unit 3051 and a reception unit 3052. The transmission unit 3051 transmits information to another apparatus in the system through the network 40. For example, the transmission unit 3051 transmits a request for an objective print job inputted by the input unit 3042 to the printer server 20. The reception unit 3052 receives information from another apparatus in the system through the network 40. For example, the reception unit 3052 receives the objective print job from the printer server 20.

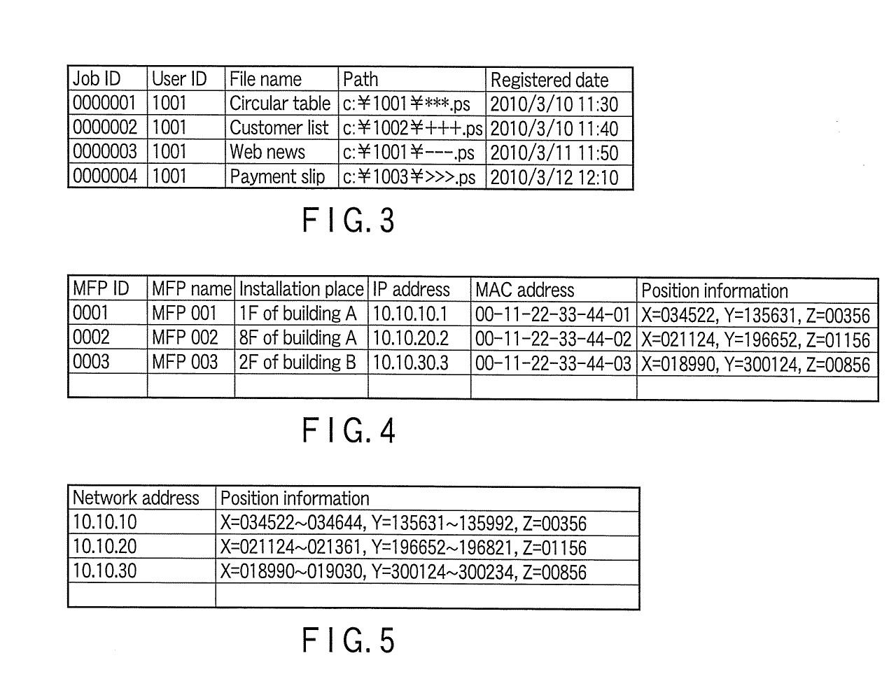

Next, various information stored in the memory 202 of the printer server 20 will be described. Incidentally, a method of acquiring various information stored in the memory 202 by the printer server 20 described below is not particularly limited. FIG. 3 is a view showing a job management table stored in the memory 202. The job management table registers information relating to print jobs stored in the memory 202. Incidentally, in the first embodiment, a print job registered in the job management table is called a registered print job. As shown in FIG. 3, the job management table registers a job ID, a user ID, a file title, a path and a registered date for each registered print job. The job ID represents an ID assigned to each registered print job registered in the job management table. The user ID represents an ID inputted in the client PC 10 in order to register a print job in the printer server 20. The file title represents a file title corresponding to the print job. The path represents a path to each registered print job stored in the memory 202. The registered date represents a date when the print job is registered in the printer server 20. That is, in the memory 202, the registered print job is correlated with the user ID and is managed.

FIG. 4 is a view showing an MFP management table stored in the memory 202. As shown in FIG. 4, the MFP management table registers an MFP ID, an MFP name, an installation place, an IP address, a MAC address and position information for each MFP (MFP 30, 31 in the example shown in FIG. 1) effectively connected to the network 40. In the first embodiment, an MFP effectively connected to the network 40, that is, an MFP allowed for printing a document based on a print job is called a printable MFP. The MFP ID represents an ID assigned to each printable MFP. The MFP name represents an apparatus name set for each printable MFP. The installation place represents a name of a place where each printable MFP is installed. The IP address represents an IP address assigned to each printable MFP. The MAC address represents a MAC address assigned to each printable MFP. The position information represents information to specify a position where each MFP is installed. The CPU 201 acquires, for example, information to be registered in the MFP management table from each printable MFP at an arbitrary timing, and updates the MFP management table as needed.

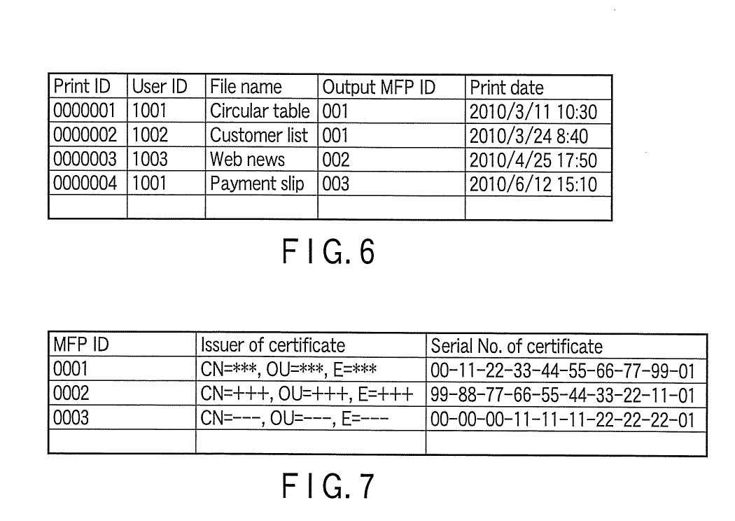

FIG. 5 is a view showing a network address-position information table stored in the memory 202. Each network address and position information are correlated and are registered in the network address-position information table. The network address represents a network address assigned to each sub-network in the system. The position information represents information to specify a position of each sub-network. FIG. 6 is a view showing a print log table stored in the memory 202. The print log table registers a print ID, a user ID, a file name, an output MFP ID and a print date. In the first embodiment, an MFP that allowed output (print) of a document based on a registered print job in the past is called an output MFP. The print ID represents an ID assigned to a registered print job transmitted to the output MFP from the printer server 20. The user ID represents a user ID corresponding to the registered print job transmitted to the output MFP from the printer server 20. The file name represents a file name corresponding to the registered print job transmitted to the output MFP from the printer server 20. The output MFP ID represents an MFP ID (previously defined in the MFP management table) corresponding to the output MFP as a transmission destination of the registered print job. The print date represents a date when the registered print job is transmitted from the printer server 20 to the output MFP. The CPU 201 updates the print log table each time the registered print job is transmitted from the printer server 20 to the output MFP.

FIG. 7 is a view showing a certificate management table stored in the memory 202. The certificate management table registers an MFP ID, an issuer of a certificate, and a serial number of the certificate. The MFP ID represents an ID assigned to each MFP. The issuer of the certificate and the serial number of the certificate indicate information to specify a public key certificate. The memory 202 uses the certificate management table and manages the public key certificate stored in the server 20. The public key certificate is used when the registered print job is encrypted and transmitted from the printer server 20 to the MFP.

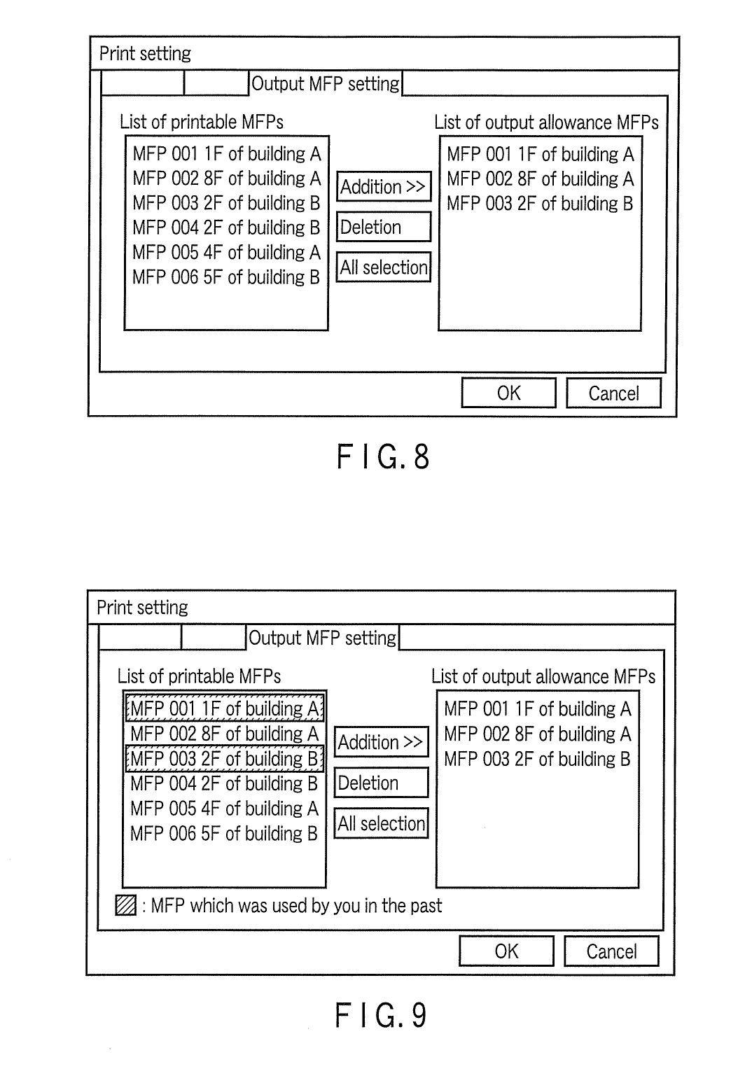

Next, print setting in the client PC 10 will be described. FIG. 8 is a screen view of the print setting displayed on the display unit 104. When the user performs predetermined inputs in the input unit 103 at the time of transmitting a print job to the printer server 20 from the client PC 10 in which the user ID is authenticated, the CPU 101 starts a printer driver stored in the memory 102, and displays a screen of print setting on the display unit 104. The screen of the print setting includes a list of printable MFPs and a list of output allowance MFPs. The list of printable MFPs includes information of printable MFPs registered in the MFP management table. The list of output allowance MFPs includes information of at least one MFP (hereinafter referred to as an output allowance MFP) which allows the user to output (print) a document based on a print job among the printable MFPs included in the list of printable MFPs. The list of printable MFPs displays MFP names of the plural printable MFPs, and names of installation places. For example, the CPU 101 creates the list of printable MFPs as described below. The CPU 101 transmits an acquisition request for the MFP management table to the printer server 20 through the transmission unit 1051. The CPU 101 acquires the MFP management table from the printer server 20 through the reception unit 1052, and stores in the memory 102. The CPU 101 acquires information of the MFP name and the name of the installation place from the MFP management table, and creates the list of printable MFPs. The CPU 101 displays the screen of the print setting including the list of printable MFPs on the display unit 104.

The user uses the input unit 103 on the screen of the print setting, and can select (add, delete) a desired output allowance MFP among the printable MFPs. The CPU 101 displays the MFP name and the name of the installation place of at least one output allowance MFP selected by the user in the list of output allowance MFP. That is, the user can set at least one output allowance MFP for each print job.

FIG. 9 is a screen view showing another example of print setting displayed on the display unit 104. The screen of the print setting includes a list of printable MFPs and a list of output allowance MFPs. On the screen of the print setting shown in FIG. 9 and in the list of printable MFPs, information of a printable MFP which was used in the past by the user using the client PC 10 is colored and highlighted.

For example, the CPU creates the list of printable MFPs as described below. The CPU 101 transmits an acquisition request for the MFP management table and the print log table to the printer server 20 through the transmission unit 1051. The CPU 101 acquires the MFP management table and the print log table from the printer server 20 through the reception unit 1052, and stores in the memory 102. The CPU 101 acquires the information of the MFP name and the name of installation place from the MFP management table, and creates the list of printable MFPs. Further, the CPU 101 acquires the output MFP ID corresponding to the user ID authenticated in the client PC 10 from the print log table. The CPU 101 acquires the printable MFP corresponding to the output MFP ID from the MFP management table. The CPU 101 colors the information of the printable MFP corresponding to the output MFP ID in the list of printable MFPs and displays on the screen of the print setting. The user can easily recognize the printable MFP used in the past by himself or herself by merely seeing the list of printable MFPs. Incidentally, although the CPU 101 colors the information of the printable MFP corresponding to the output MFP ID in the list of printable MFPs and displays, no limitation is made, and any highlighted display, such as shading or change of font, may be adopted.

Incidentally, in the list of printable MFPs, information of a printable MFP located at a position (within a specified distance) close to the client PC 10 may be highlighted. In this case, for example, the CPU 101 creates a list of printable MFPs as described below. The CPU 101 transmits an acquisition request for the MFP management table and the network address-position information table to the printer server 20 through the transmission unit 1051. The CPU 101 acquires the MFP management table and the network address-position information table from the printer server 20 through the reception unit 1052, and stores in the memory 102. The CPU 101 acquires information of the MFP name and the name of the installation place from the MFP management table, and creates a list of printable MFPs. Further, the CPU 101 acquires the position information of the client PC 10 from the IP address of the client PC 10. The CPU 101 refers to the network address-position information table, and acquires a printable MFP within the specified distance from the position of the client PC 10 based on the position information of the printable MFP and the position information of the client PC 10 acquired from the MFP management table. The CPU 101 highlights the information of the printable MFP within the specified distance from the position of the client PC 10 in the list of printable MFPs, and displays on the screen of the print setting. The user can easily recognize the printable MFP located at the close position from the position of the client PC 10 by merely seeing the list of printable MFPs.

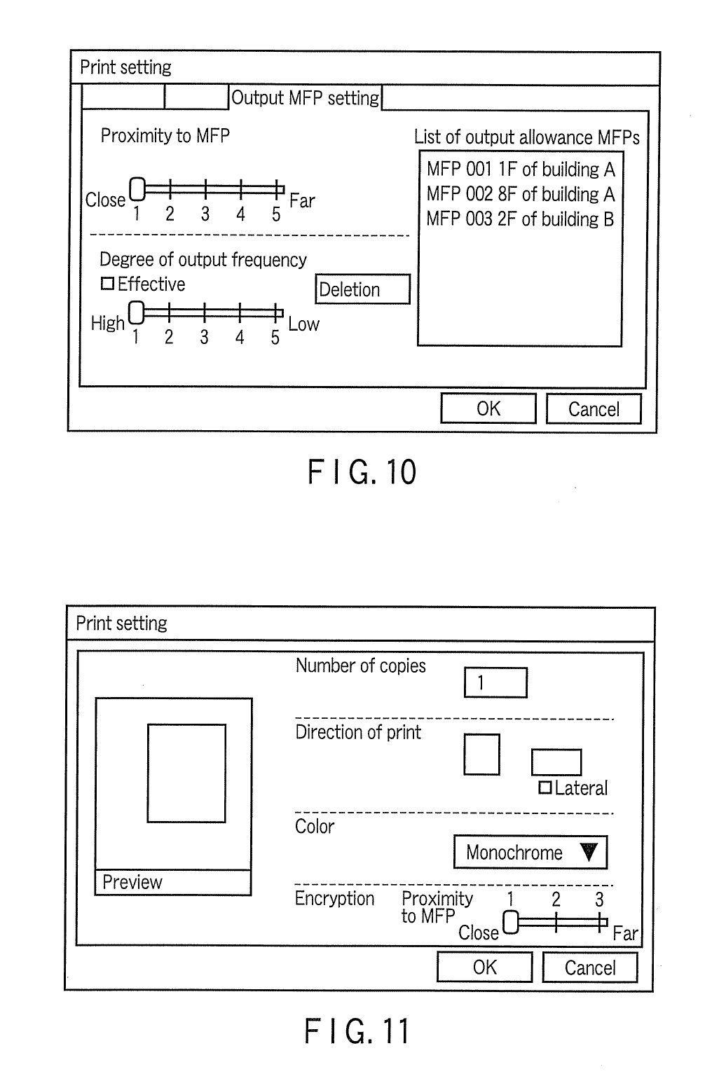

FIG. 10 is a screen view showing another example of print setting displayed on the display unit 104. The screen of the print setting includes two adjustment bars and a list of output allowance MFPs. On the screen shown in FIG. 10, the adjustment bars include an adjustment bar corresponding to the proximity (distance) of a printable MFP from the client PC 10 and an adjustment bar corresponding to the use frequency of a printable MFP which was used in the past by the user using the client PC 10.

First, the adjustment bar corresponding to the proximity of the printable MFP will be described. The CPU 101 assigns stepwise parameters corresponding to the proximity (distance) from the client PC 10 to printable MFPs as described below. When starting a printer driver, the CPU 101 transmits an acquisition request for the MFP management table and the network address-position information table to the printer server 20 through the transmission unit 1051. The CPU 101 acquires the MFP management table and the network address-position information table from the printer server 20 through the reception unit 1052, and stores in the memory 102. The CPU 101 acquires the position information of the client PC 10 from the IP address of the client PC 10. Then, the CPU 101 refers to the network address-position information table, and assigns the stepwise parameters to the respective printable MFPs by classifying the proximity from the position of the client PC 10 into several stages (here, five stages) based on the position information of the respective printable MFPs acquired from the MFP management table and the position information of the client PC 10, and stores the assigned parameters in the memory 102.

When the user uses the input unit 103 to validate the adjustment of the adjustment bar corresponding to the proximity of the printable MFP and changes the setting of the stage, the CPU 101 acquires the information of the printable MFP to which the parameter corresponding to the stage is assigned. Then, the CPU 101 displays the acquired information of the printable MFP as the information of the output allowance MFP in the list of output allowance MFPs. The CPU 101 displays the MFP name and the name of installation place of at least one output allowance MFP in the list of output allowance MFP. Incidentally, the CPU 101 assigns the parameter corresponding to the proximity of the printable MFP in such a way that for example, the first stage is assigned to three MFPs close to the client PC 10, and the second stage is assigned to six MFPs next close thereto.

Next, the adjustment bar corresponding to the use frequency will be described. The CPU 101 sets stepwise parameters corresponding the use frequency as described below. When starting the printer driver, the CPU 101 transmits an acquisition request for the MFP management table and the print log to the printer server 20 through the transmission unit 1051. The CPU 101 acquires the MFP management table and the print log table from the printer server 20 through the reception unit 1052 and stores in the memory 102. The CPU 101 calculates the output frequency (number of times of output) of each printable MFP based on the output MFP ID corresponding to the user ID authenticated in the client PC 10 from the print log table. Incidentally, although the CPU 101 calculates the output frequency of each printable MFP, the CPU 201 of the printer server 20 may calculate the output frequency. In this case, the memory 202 of the printer server 20 previously stores the output frequency of each printable MFP for each user ID, and the CPU 101 may acquire the output frequency. The CPU 101 classifies the output frequency into several stages (here, five stages) in descending order, assigns the stepwise parameters to the respective printable MFPs, and stores the assigned parameters in the memory 102.

When the user uses the input unit 103 to validate the adjustment of the adjustment bar corresponding to the output frequency, and changes the setting of the stage, the CPU 101 acquires the information of the printable MFP for which the parameter corresponding to the stage is set. Then, the CPU 101 displays the acquired information of the printable MFP as the information of the output allowance MFP in the list of output allowance MFPs. The CPU 101 displays the MFP name and the name of installation place of at least one output allowance MFP in the list of output allowance MFPs. Incidentally, the CPU 101 assigns the parameter corresponding to the output frequency in such a way that for example, the first stage is assigned to the output allowance MFP whose output frequency is 20 or more, and the second stage is assigned to the output allowance MFP whose output frequency is 15 or more.

Incidentally, the user uses the input unit 103 and can set both the adjustment bar corresponding to the proximity of the printable MFP and the adjustment bar corresponding to the use frequency of the MFP. In this case, the CPU 101 acquires the information of the printable MFP including both the parameter corresponding to the stage of the adjustment bar corresponding to the proximity of the printable MFP and the parameter corresponding to the stage of the adjustment bar corresponding to the use frequency of the MFP, and displays the information as the information of the output allowance MFP in the list of output allowance MFPs.

According to the first embodiment, since the output allowance MFP can be freely set for each print job on the screen of the print setting of the printer driver by the authority of the user, the usability of the print job is improved, and unauthorized printing can be prevented. Further, on the screen of the print setting as shown in FIG. 9 or FIG. 10, the user can save the trouble of individually selecting the output allowance MFP.

Next, the transmission of the print job from the client PC 10 to the printer server 20 will be described. When the user inputs a print instruction of a document after using the input unit 103 to set an output allowance MFP on the screen of the print setting as shown in FIG. 8 to FIG. 10, the CPU 101 writes the MFP ID corresponding to the output allowance MFP in PJL. Thereafter, the CPU 101 transmits the print job including the information of the output allowance MFP by the PJL (Printer job Language) to the printer server 20 through the transmission unit 1051.

Next, management of a print job in the printer server 20 will be described. When receiving a print job from the client PC 10 through the reception unit 2032, the CPU 201 stores the print job in the memory 202. Further, the CPU 201 registers various information relating to the print job in the job management table. That is, the CPU 201 updates the job management table each time the print job is received.

Next, printing of a document based on a registered print job in the MFP 30 will be described. When the user uses the input unit 3042 and inputs an acquisition request for the registered print job list in the MFP 30 in which the user ID is authenticated, the CPU 301 transmits the acquisition request for the registered print job list to the printer server 20. The printer server 20 refers to the print job management table, acquires the information of the registered print job corresponding to the authenticated user ID, and creates the registered print job list. Incidentally, when creating the registered print job list, the CPU 301 determines whether the output allowance MFPs set in the respective registered print jobs include the MFP which transmitted the acquisition request for the registered print job list. The CPU 301 adds the information of the registered print job including the MFP, which transmitted the acquisition request for the registered print job list, as the output allowance MFP into the registered print job list. In other words, the information of the registered print job not including the MFP, which transmitted the acquisition request for the registered print job list, as the output allowance MFP is not added to the registered print job list.

The CPU 301 transmits the registered print job list to the MFP 30 in which the user ID is authenticated. The CPU 301 displays the registered print job list received through the reception unit 3052 on the display unit 3041. The user uses the input unit 2042 and can select the registered print job desired to be printed from the registered print job list displayed on the display unit 3041. The CPU 301 acquires the selected registered print job from the printer server 20, and controls to print the document based on the registered print job by the image forming unit 303.

Next, print setting in the client PC 10 according to a second embodiment will be described. FIG. 11 is a screen view of print setting displayed on the display unit 104. When the user makes an input in the input unit 103 at the time of transmitting a print job to the printer server 20 from the client PC 10 in which the user ID is authenticated, the CPU 101 starts a printer driver stored in the memory 102, and displays the screen of print setting on the display unit 104. The screen of the print setting includes setting of the presence or absence of encryption when the print job is transmitted to the printer server 20, in addition to basic setting, such as the number of copies, direction of printing and color/monochrome.

When the user sets, on the screen of the print setting, that there is encryption, the CPU 101 displays the adjustment bar corresponding to the distance explained in the first embodiment on the screen of the print setting. In FIG. 11, although the adjustment bar corresponding to the distance includes three stages, five stages may be adopted as explained in the first embodiment, and no limitation is made. When the user uses the input unit 103 and changes the setting of the stage of the adjustment bar corresponding to the proximity of the printable MFP, the CPU 101 acquires the information of the printable MFP to which the parameter corresponding to the stage is assigned. The CPU 101 sets the acquired information of the printable MFP as the information of the output allowance MFP in the list of output allowance MFPs. Incidentally, as described in the first embodiment, the output allowance MFP may be set by the adjustment bar corresponding to the use frequency of the printable MFP or may be set by individual selection.

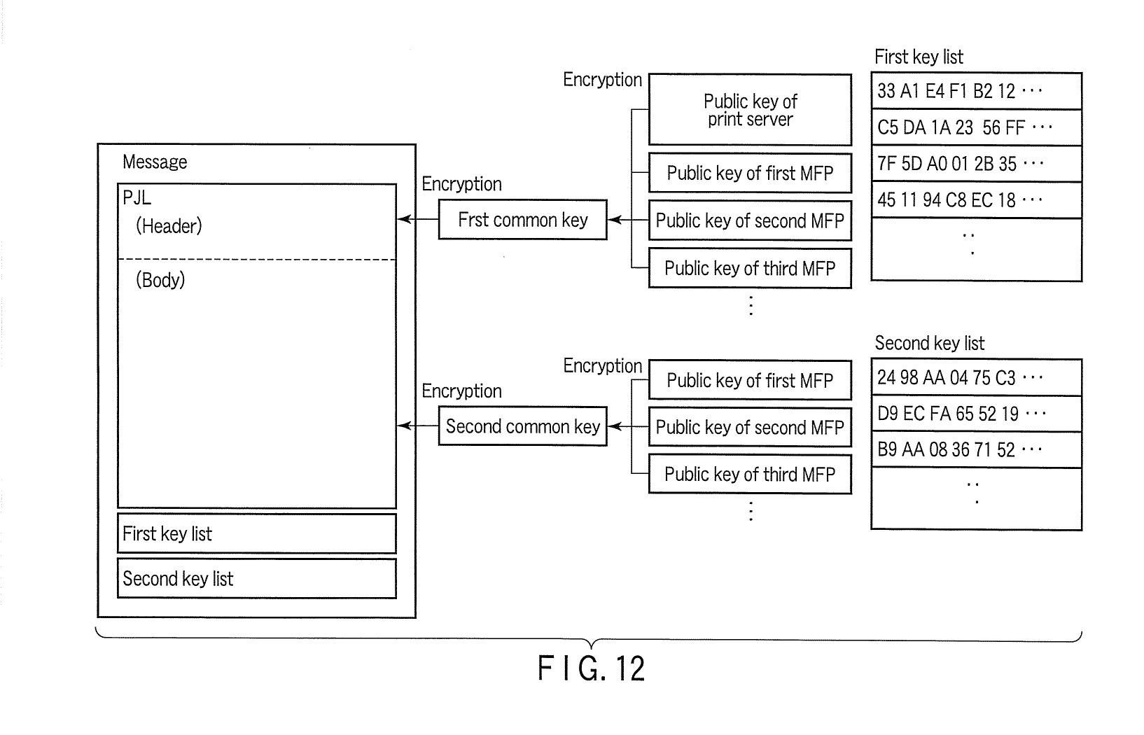

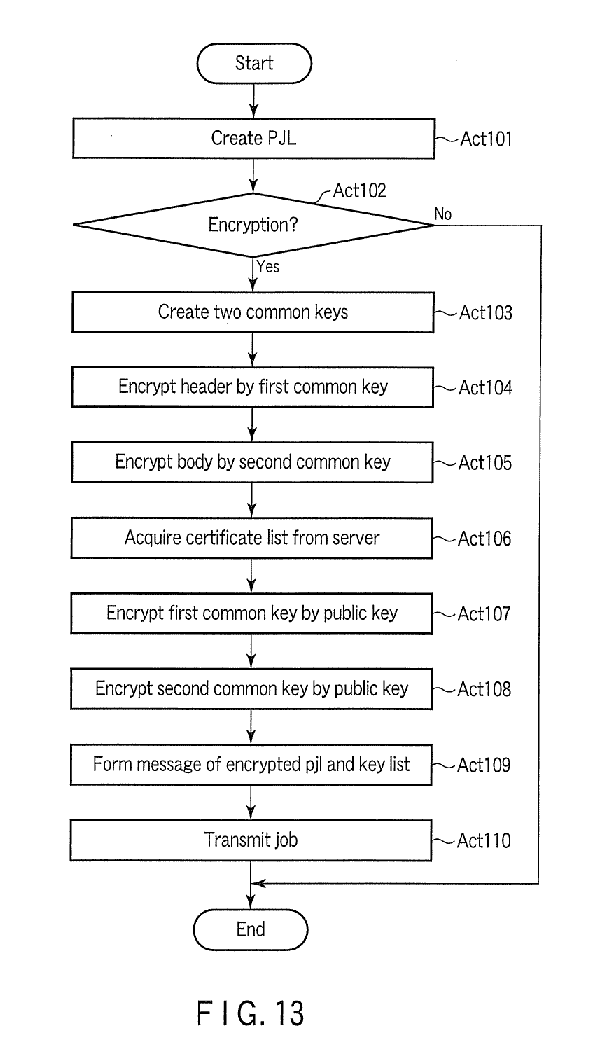

Next, transmission of a pint job from the client PC 10 to the printer server 20 will be described. FIG. 12 is a view showing encryption of PJL created by the printer driver. In the second embodiment, the encryption of the PJL by a public key encryption system will be described. FIG. 13 is a flowchart showing the processing of the encryption shown in FIG. 12 in the client PC 10. Incidentally, it is assumed that a secret key, a public key and an electronic certificate are installed in the printer server 20, and the MFPs 30 and 31. In the printer server 20, the electronic certificate of a printable MFP is stored in a certificate store.

First, the CPU 101 writes the MFP ID of the output allowance MFP included in the list of output allowance MFPs into the PJL based on a document print instruction and creates the PJL (Act 101). The CPU 101 determines whether the encryption of the PJL is instructed (Act 102). When the encryption is not specified (Act 102, No), the CPU 101 transmits the print job to the printer server 20 without performing the encryption communication.

When the encryption is specified (Act 102, Yes), the CPU 101 creates two common keys based on the public key certificate of the printer server 20 (Act 103). At Act 103, the CPU 101 creates the first common key and the second common key. The CPU 101 encrypts the header of the PJL by the first common key (Act 104). The CPU 101 encrypts the body of the PJL by the second common key (Act 105). The CPU 101 acquires a list of the certificates from the printer server 20 (Act 106). At Act 106, the CPU 101 acquires the public key certificate of the printer server 20 and public key certificates of all output allowance MFPs included in the list of output allowance MFPs from the printer server 20.

The CPU 101 encrypts the first common key by the public key of the printer server 20 and the public keys of all the output allowance MFPs (Act 107). Incidentally, in the second embodiment, the list of the public key of the printer server 20 and the public keys of all the output allowance MFPs used for encrypting the first common key is a first key list. The CPU 101 encrypts the second common key by the public keys of all the output allowance MFPs (Act 108). In the second embodiment, the list of the public keys of all the output allowance MFPs used for encrypting the second common key is a second key list.

The CPU 101 uses the encrypted PJL, the encrypted first key list, and the encrypted second key list to form one message (Act 109). The CPU 101 transmits the message as the print job to the printer server 20 through the transmission unit 1051 (Act 110).

According to the second embodiment, the output allowance MFP is limited, so that the processing speed of encryption of the print job in the client PC 10 becomes high, and the amount of data transmitted from the client PC 10 to the printer server 20 can be reduced. Besides, in the print server 20, since reference can be made to the print setting information by decoding the header of the PJL included in the print job, the processing, such as confirmation of the registered user name or resetting of the print setting, can be performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer server type print system comprising:
a plurality of digital multi-function peripherals;
an information processing apparatus including
a display unit configured to display information of the plurality of digital multi-function peripherals,
an input unit configured to accept setting of at least one digital multi-function peripheral allowed for outputting among the plurality of digital multi-function peripherals, and
a first control unit configured to transmit a print job including information of the digital multi-function peripheral allowed for outputting; and
a printer server including
a reception unit configured to receive the print job,
a memory configured to store information relating to the print job received by the reception unit, and
a second control unit configured to manage the print job stored in the memory.

2. The system of claim 1, wherein the second control unit correlates the print job with a user ID and manages the print job.

3. The system of claim 1, wherein the second control unit manages information of the plurality of digital multi-function peripherals.

4. The system of claim 3, wherein the first control unit acquires the information of the plurality of digital multi-function peripherals from the printer server.

5. The system of claim 2, wherein the second control unit manages a print log of the print job.

6. The system of claim 5, wherein the first control unit acquires the print log of the print job corresponding to a specified user ID, and highlights at least one digital multi-function peripheral having a high use frequency among the plurality of digital multi-function peripherals based on the print log.

7. The system of claim 5, wherein the first control unit acquires the print log of the print job corresponding to a specified user ID, and sets information of the plurality of digital multi-function peripherals by stepwise parameters corresponding to a use frequency based on the print log.

8. The system of claim 1, wherein the second control unit manages position information where the plurality of digital multi-function peripherals are installed.

9. The system of claim 8, wherein the first control unit acquires the position information from the printer server, and sets information of the plurality of digital multi-function peripherals by stepwise parameters corresponding to distances from the information processing apparatus based on the position information.

10. The system of claim 1, wherein the second control unit manages a public key certificate of each of the plurality of digital multi-function peripherals.

11. The system of claim 10, wherein the input unit accepts setting of presence or absence of encryption of the print job.

12. The system of claim 11, wherein when the setting indicates that there is encryption, the first control unit encrypts the print job by a public key encryption system.

13. The system of claim 2, wherein at least one of the plurality of digital multi-function peripherals includes
a third control unit configured to acquire a list of at least one print job corresponding to an inputted user ID from the printer server, and
a display unit configured to display the list.

14. The system of claim 13, wherein the second control unit transmits the list, which includes, as the digital multi-function peripheral allowed for outputting, a digital multi-function peripheral transmitting an acquisition request for the list, to the digital multi-function peripheral.

15. A print job managing method comprising:
in an information processing apparatus,
displaying information of a plurality of digital multi-function peripherals;
accepting setting of at least one digital multi-function peripheral allowed for outputting among the plurality of digital multi-function peripherals; and
transmitting a print job including information of the digital multi-function peripheral allowed for outputting; and
in a printer server,
receiving the print job;
storing information relating to the print job; and
managing the print job.

16. The method of claim 15, comprising:
in the information processing apparatus,
acquiring a print log of the print job corresponding to a specified user ID; and
highlighting at least one digital multi-function peripheral having a high use frequency among the plurality of digital multi-function peripherals based on the print log.

17. The method of claim 15, comprising:
in the information processing apparatus,
acquiring a print log of the print job corresponding to a specified user ID; and
setting information of the plurality of digital multi-function peripherals by stepwise parameters corresponding to a use frequency based on the print log.

18. The method of claim 15, comprising:
in the information processing apparatus,
acquiring position information from the printer server; and
setting information of the plurality of digital multi-function peripherals by stepwise parameters corresponding to a distance from the information processing apparatus based on the position information.

19. The method of claim 15, comprising:
in the information processing apparatus,
accepting setting of presence or absence of encryption of the print job; and
encrypting the print job by a public key encryption system when the setting indicates that there is encryption.

20. The method of claim 19, comprising:
in the printer server, transmitting a list of print jobs including, as the digital multi-function peripheral allowed for outputting, a digital multi-function peripheral to the digital multi-function peripheral.
